(19) United States
(12) Patent Application Publication
(10) Pub. No.: US 2019/0349054 A1
(43) Pub. Date: Nov. 14, 2019

(54) DATA MULTIPLEXING METHOD, DATA PARSING METHOD, APPARATUS, AND SYSTEM

(71) Applicant: HUAWEI TECHNOLOGIES CO., LTD., Shenzhen (CN)

(72) Inventors: Gao XIANG, Chengdu (CN); Lei CHEN, Shenzhen (CN)

(21) Appl. No.: 16/521,600

(22) Filed: Jul. 25, 2019

Related U.S. Application Data
(63) Continuation of application No. PCT/CN2018/073439, filed on Jan. 19, 2018.

(30) Foreign Application Priority Data
Jan. 25, 2017 (CN) 201710061366.3

(51) Int. Cl. H04B 7/06; H04L 5/00; H04B 17/309

(52) U.S. Cl. CPC H04B 7/0626; H04B 17/309; H04L 5/0053; H04L 5/0007

(57) ABSTRACT

Embodiments of this application provide a data multiplexing method, a network-side device, and a terminal. The method includes: transmitting, by a network-side device, a channel state information-reference signal CSI-RS and a data signal to a terminal, where the CSI-RS is used for channel state measurement or beam quality measurement; and sending, by the network-side device, CSI-RS multiplexing indication information to the terminal, where the CSI-RS multiplexing indication information is used to indicate whether frequency division multiplexing is performed on the data signal transmitted to the terminal and the CSI-RS. In the embodiments of this application, the CSI-RS multiplexing indication information is used to indicate whether multiplexing is performed on the CSI-RS and a data channel, so that multiplexing on the CSI-RS and the data channel becomes possible. In addition, the terminal can correctly parse user data based on the CSI-RS multiplexing indication information, so that resource utilization efficiency of the terminal is greatly improved.

### CROSS-REFERENCE TO RELATED APPLICATIONS

This application is a continuation of International Application No. PCT/CN2018/073439, filed on Jan. 19, 2018, which claims priority to Chinese Patent Application No. 201710061366.3, filed on Jan. 25, 2017. The disclosures of the aforementioned applications are hereby incorporated by reference in their entireties

### TECHNICAL FIELD

Embodiments of this invention relate to the field of wireless communications technologies, and in particular, to a data multiplexing method, a data parsing method, an apparatus, and a system.

### BACKGROUND

With an increase in communication requirements and development of communications technologies, compared with an LTE (Long Term Evolution, long term evolution) system, a future communications system is to use a higher carrier frequency, for example, 39 GHz, to implement wireless communication with a higher bandwidth and a higher transmission rate.

Because a carrier frequency is greatly increased, a carrier wavelength becomes shorter, and diffraction and scattering capabilities of a radio signal decrease. Therefore, the radio signal suffers from more serious fading in a space propagation process. As a result, coverage capability of a base station is limited, or even a transmitted radio signal can hardly be detected at a receive end. In view of this, in the future communications system, beamforming (beamforming) technology is used to obtain a beam with good directivity, to increase power in a transmit direction, thereby increasing a signal to interference plus noise ratio (Signal to Interference plus Noise Ratio, SINR) at the receive end. To expand a coverage area and control costs of an antenna array, hybrid beamforming (Hybrid beamforming) becomes an option. The hybrid beamforming includes both digital beamforming (Digital beamforming) of a baseband and analog beamforming (Analog beamforming) at a radio frequency end.

As shown in FIG. 1, when a base station performs beam scanning, a beam being scanned may be unable to cover a terminal. On the contrary, if the base station is not performing beam scanning, a beam serving the terminal may be directed at the terminal, and a CSI-RS that can be sent in the beam is used for CSI measurement.

The inventor finds, in a process of inventing the technical solutions of this disclosure, that resource utilization is extremely low when a CSI-RS is responsible for a CSI measurement function.

### SUMMARY

To resolve the technical problem in the prior art, embodiments of the present disclosure provide a data multiplexing method, a network-side device, and a terminal.

Embodiments of the present disclosure provide a data multiplexing method. The method may include: sending, by a network-side device, a channel state information-reference signal (CSI-RS) and a data signal to a terminal, where the CSI-RS is used for channel state measurement or beam quality measurement; and ending by the network-side device, CSI-RS multiplexing indication information to the terminal, where the CSI-RS multiplexing indication information is used to indicate whether frequency division multiplexing is performed on the data signal transmitted to the terminal and the CSI-RS. The method may also include, after receiving the CSI-RS multiplexing indication information from the network-side device, parsing, by the terminal based on the CSI-RS multiplexing indication information, the data signal in an OFDM symbol that is indicated by the CSI-RS multiplexing indication information and in which the CSI-RS is located, where frequency division multiplexing is performed on the CSI-RS and the data signal.

In an implementation, the network-side device carries the CSI-RS multiplexing indication information using L1/L2/L3 signaling data, and sends the L1/L2/L3 signaling data to the terminal.

The L1 signaling data may include DCI signaling data, the L2 signaling may include MAC CE signaling data, and the L3 signaling may include RRC signaling data.

In this embodiment of this disclosure, the CSI-RS multiplexing indication information is used to indicate whether multiplexing is performed on the CSI-RS and a data channel, so that multiplexing on the CSI-RS and the data channel becomes possible. In addition, the terminal can correctly parse user data based on the CSI-RS multiplexing indication information, so that resource utilization efficiency of the terminal is greatly improved.

According to another aspect, an embodiment of this disclosure provides a network-side device. The network-side device may be a base station, or may be a control node. The network-side device includes: a transceiver, configured to transmit a channel state information-reference signal CSI-RS and a data signal to a terminal, where the CSI-RS is used for channel state measurement or beam quality measurement. The transceiver is further configured to send CSI-RS multiplexing indication information to the terminal, where the CSI-RS multiplexing indication information is used to indicate whether frequency division multiplexing is performed on the data signal transmitted to the terminal and the CSI-RS, so that the terminal parses the data signal based on the CSI-RS multiplexing indication information.

According to another aspect, an embodiment of this disclosure provides a base station. The base station is operative to perform functions of the base station in the foregoing method. The functions may be implemented by hardware, software or a combination of hardware and software. Hardware logic or software programs may include one or more modules that perform corresponding functions.

In one embodiment, a structure of the base station includes a processor and a transceiver. The processor is configured to support the base station in performing the corresponding function in the foregoing method. The transceiver is configured to: support communication between the base station and user equipment (UE), send information or signaling in the foregoing method to the UE, and receive information or signaling sent by the base station. The base station may further include a memory. The memory is coupled to the processor, and stores program instructions and data that are necessary to the base station.

According to still another aspect, an embodiment of this disclosure provides a control node. The control node may include a controller/processor, a memory, and a communications unit. The controller/processor may be configured to coordinate resource management and configuration between a plurality of base stations. The memory may be configured to store program code and data of the control node. The communications unit is configured to support the control node in communicating with a base station, for example, sending information about a configured resource to the base station.

According to still another aspect, an embodiment of this disclosure provides a terminal. The terminal is operative to perform functions of the terminal described in the foregoing method. The functions may be implemented by hardware, where a structure of the terminal includes a transceiver and a processor; or may be implemented by hardware that executes related software programs. Hardware logic or software programs may include one or more modules corresponding to the functions. The module may be software and/or hardware. The terminal includes: the transceiver, configured to receive a channel state information-reference signal CSI-RS and a data signal from a network-side device, where the CSI-RS is used for channel state measurement or beam quality measurement; and the processor, configured to parse the data signal in an orthogonal frequency division multiplexing OFDM symbol indicated by the CSI-RS multiplexing indication information, where frequency division multiplexing is performed on the data signal and the CSI-RS in the OFDM symbol.

According to another aspect, an embodiment of this disclosure further provides a data multiplexing method, a network-side device, and a terminal, where the network-side device notifies the terminal of all analog beam information of a CSI-RS in a transmission timeslot and information about an analog beam for transmitting data; and the terminal determines whether a CSI-RS analog beam that is the same as an analog beam for transmitting a data signal of the terminal is present; and in the event that the CSI-RS analog beam is present, the terminal determines that the data signal is mapped into an OFDM symbol in which the CSI-RS is located, and further, the terminal parses the data signal in the OFDM symbol into which the data signal is mapped; or

in the event that the CSI-RS analog beam is not present, the terminal determines that the data signal is not mapped into an OFDM symbol in which the CSI-RS is located.

In this embodiment of this disclosure, the network-side device sends the analog beam information of the CSI-RS and the analog beam information of the data signal to the terminal, and the terminal determines, based on the analog beam information of the CSI-RS and the analog beam information of the data signal, whether multiplexing is performed on the CSI-RS and the data signal, and therefore can correctly parse user data, thereby greatly improving resource utilization efficiency of the terminal.

In an implementation, when an analog beam of the CSI-RS and an analog beam for transmitting the data signal of the terminal are a mutually matched beam pair, is the terminal determines that frequency division multiplexing is performed on the data signal and the CSI-RS.

According to still another aspect, an embodiment of this disclosure provides a communications system. The communications system includes the base station and the terminal in the foregoing aspects. In one embodiment, the communications system may further include the control node in the foregoing embodiment.

According to yet another aspect, an embodiment of this disclosure provides a computer storage medium, configured to store a computer software instruction used by the foregoing network-side device. The computer software instruction includes a program designed for executing the foregoing aspects.

According to yet another aspect, an embodiment of this disclosure provides a computer storage medium configured to store computer software instructions that are used by the foregoing terminal. The computer software instructions include one or more programs designed for executing the foregoing aspects.

### DESCRIPTION OF DRAWINGS

To describe the technical solutions in the embodiments of this disclosure more clearly, the following briefly describes the accompanying drawings required for describing the embodiments of this disclosure. Apparently, the accompanying drawings in the following description are merely some embodiments of this disclosure, and a person of ordinary skill in the art may derive other drawings from these accompanying drawings without creative efforts.

FIG. 1 is a schematic diagram illustrating a base station that performs beam scanning;

FIG. 2 is a schematic diagram of a pilot pattern in which a CSI-RS is used for beam measurement;

FIG. 3 is a schematic diagram of a communications system according to an embodiment of this disclosure;

FIG. 4 is a schematic diagram of data multiplexing between a terminal and a network-side device according to an embodiment of this disclosure;

FIG. 5 is a schematic diagram of data multiplexing between a terminal and a network-side device according to another embodiment of this disclosure;

FIG. 6 is a schematic diagram of CSI-RS multiplexing indication information in Embodiment 1 of a data multiplexing method according to some embodiments of this disclosure;

FIG. 7 is a schematic diagram of CSI-RS multiplexing indication information in Embodiment 2 of a data multiplexing method in which DCI is used to indicate CSI-RS multiplexing in a plurality of OFDM symbols according to some embodiments of this disclosure;

FIG. 8 is a schematic diagram of CSI-RS multiplexing indication information in Embodiment 3 of a data multiplexing method according to some embodiments of this disclosure;

FIG. 9 is a schematic diagram of CSI-RS multiplexing indication information in Embodiment 4 of a data multiplexing method according to embodiments of this disclosure;

FIG. 10 is a schematic flowchart of Embodiment 5 of a data multiplexing method according to some embodiments of this disclosure;

FIG. 11 is a schematic diagram of deducing a multiplexing status based on CSI-RS beam information in Embodiment 5 of a data multiplexing method according to some embodiments of this disclosure; and

FIG. 12 is another schematic diagram of deducing a multiplexing status based on CSI-RS beam information in Embodiment 5 of a data multiplexing method according to other embodiments of this disclosure.

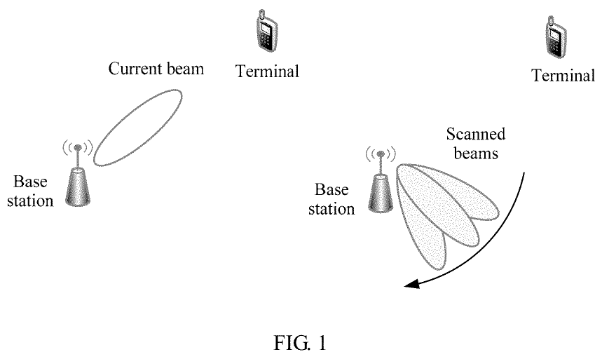

### DESCRIPTION OF EMBODIMENTS

To further describe this disclosure, related technologies in the embodiments of this disclosure are first described briefly.

To obtain features such as a higher transmission bandwidth and a higher transmission rate, a next-generation communications system is to use a higher carrier frequency relative to that of Long Term Evolution (LTE, Long Term Evolution).

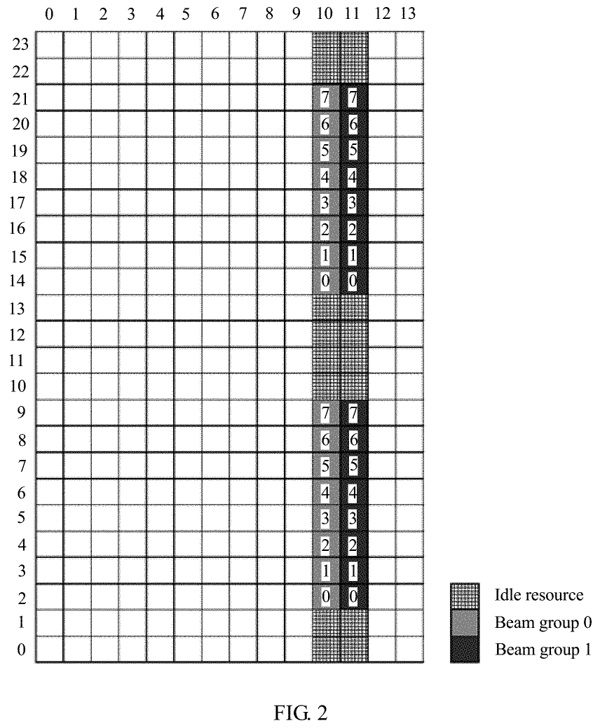

During high-frequency communication, beam scanning needs to be performed to implement beam pairing on a base station side and a user side, to ensure relatively good communication quality. FIG. 2 shows an example of a pilot pattern in which a CSI-RS is used for beam measurement. The horizontal axis represents time showing a sequence of OFDM symbols (e.g., OFDM symbols 0 to 13) and the vertical axis represent frequency (e.g., subcarriers 0 to 23). In the example of the pilot pattern, a CSI-RS is mapped into both an OFDM symbol 10 and an OFDM symbol 11 that are consecutive, and a maximum of eight simultaneously-emitted analog beams can be scanned in each OFDM symbol. Herein, the analog beams are referred to as a beam group. Each analog beam corresponds to one beam port, and a frequency division multiplexing mode or a code division multiplexing mode is used between beam ports. If scanning of more analog beams needs to be supported, more OFDM symbols can be selected for beam scanning.

The inventor discovered that in the prior art, during beam scanning, it cannot be ensured that an analog beam scheduled for transmitting data of a terminal is consistent with an analog beam used in an OFDM symbol into which a CSI-RS is mapped, and consequently although there is still an idle resource in an OFDM symbol in which the CSI-RS is used for beam measurement, the resource cannot be used to transmit a data signal of the terminal.

In a next-generation communications system, a CSI-RS not only can be responsible for a beam measurement function, but also can be responsible for a function of performing CSI measurement on a terminal. When the CSI-RS is used for CSI measurement, a terminal on which CSI measurement is performed needs to be always covered by a beam. Therefore, an analog beam does not change or does not change much during a CSI measurement process. In this case, a terminal within a coverage area of the analog beam can use an idle resource of an OFDM symbol in which the CSI-RS is located, thereby improving utilization efficiency of a user resource.

The technical solutions provided in the embodiments of this disclosure may be applied to various communications systems of a wireless cellular network, such as a Global System for Mobile Communications (Global System for Mobile Communications, GSM), a Code Division Multiple Access (Code Division Multiple Access, CDMA) system, a Wideband Code Division Multiple Access (Wideband Code Division Multiple Access Wireless, WCDMA) system, a general packet radio service (General Packet Radio Service, GPRS) system, a Long Term Evolution (Long Term Evolution, LTE) system, a Universal Mobile Telecommunications System (Universal Mobile Telecommunications System, UMTS), and a next-generation mobile communications system (for example, 5G).

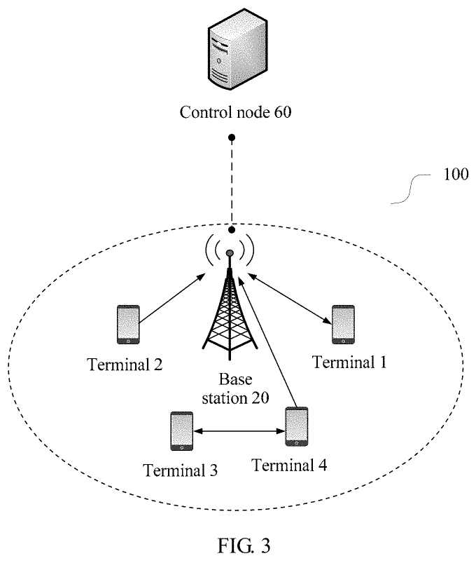

As shown in FIG. 3, an embodiment of this disclosure provides a communications system 100. The communications system 100 at least includes at least one base station (base station, BS) 20 and a plurality of terminals, for example, a terminal 1, a terminal 2, a terminal 3, and a terminal 4. A control node 60 connected to the base station 20 can centrally schedule resources in the system, and can configure resources for the terminals, make a decision on resource multiplexing, perform interference coordination, or the like.

A network-side device in the embodiments of this disclosure may include an improved system and device that function as equivalent devices in a conventional radio telecommunications system. This type of advanced or next-generation device may be included in an evolved wireless communications standard (for example, Long Term Evolution LTE). For example, an LTE system may include an evolved universal terrestrial radio access network (E-UTRAN) NodeB (eNB), a radio access node, or a similar component, but excludes a conventional base station. Any component of such types is referred to as an eNB in this specification. However, it should be understood that such types of components are not necessarily eNBs. In a next-generation communications system, “gNB” is to be used instead of eNB in the LTE system.

Specifically, the network-side device may be the base station 20 or the control node 60 shown in FIG. 3.

A base station in the embodiments of this disclosure, for example, the base station 20 shown in FIG. 3, is an apparatus that is deployed in a radio access network to provide a wireless communications function for a terminal. The base station may include a macro base station, a micro base station (also referred to as a small cell), a relay station, an access point, and the like in various forms. A device that has a base station function may have different names in systems that use different radio access technologies. For example, the device is referred to as an evolved NodeB (evolved NodeB, eNB or eNodeB) in an LTE system, and the device is referred to as a NodeB (NodeB) in a 3rd generation (3rd generation, 3G) system. For ease of description, in all the embodiments of this disclosure, the foregoing apparatuses that provide a wireless communication function for the terminal are collectively referred to as base stations or BSs.

A control node in the embodiments of this disclosure, for example, the control node 60 in the communications system shown in FIG. 3, may be connected to a plurality of base stations, and configure resources for a plurality of terminals covered by the plurality of base stations. For example, the base station may be a NodeB in a UMTS system, and the control node may be a network controller. For another example, the base station may be a small cell, and the control node may be a macro base station that covers the small cell. For still another example, the control node may be a wireless network inter-RAT coordinating controller or the like, and the base station is a base station in a wireless network. Restrictive descriptions are not provided in the embodiments of this disclosure.

A terminal in the embodiments of this disclosure, for example, the terminal 1, the terminal 2, the terminal 3, or the like in the communications system 100 shown in FIG. 3, may include various handheld devices, in-vehicle devices, wearable devices, or computing devices that have wireless communication functionality, or other processing devices connected to a wireless modem. The terminal may also be referred to as a mobile station (mobile station, MS for short), and may further include a subscriber unit (subscriber unit), a cellular phone (cellular phone), a smartphone (smartphone), a wireless data card, a personal digital assistant (personal digital assistant, PDA) computer, a tablet computer, a wireless modem (modem), a handheld (handheld) device, a laptop computer (laptop computer), a cordless phone (cordless phone), a wireless local loop (wireless local loop, WLL) station, a machine type communication (machine type communication, MTC) terminal, or the like. For ease of description, in all the embodiments of this disclosure, the devices mentioned above are collectively referred to as terminals.

System architectures and service scenarios described in the embodiments of this disclosure are intended to describe the technical solutions of the embodiments of this disclosure more clearly, and do not constitute any limitation on the technical solutions provided in the embodiments of this disclosure. A person of ordinary skill in the art is aware that, with the evolution of network architectures and emergence of new service scenarios, the technical solutions provided in the embodiments of this disclosure are also applicable to similar technical problems.

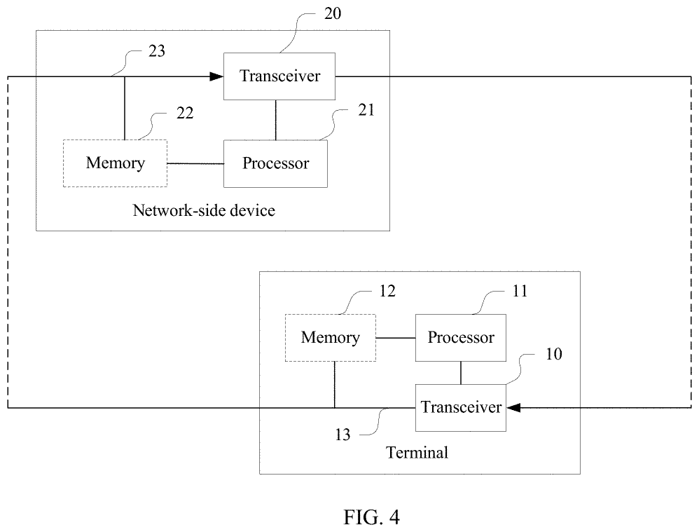

FIG. 4 is a schematic structural diagram of data multiplexing between a terminal and a network-side device according to an embodiment of this disclosure.

The terminal provided in this embodiment of this disclosure includes a transceiver 10 and a processor 11. The terminal may further include: a memory 12 configured to store computer executable instructions; and a system bus 13, where the system bus 13 is connected to the processor 11, the transceiver 10, the memory 12, and the like. The network-side device includes a transceiver 20 and a processor 21. The network-side device may further include: a memory 22 configured to store computer executable instructions; and a system bus 23, where the system bus 23 is connected to the processor 21, the transceiver 20, the memory 22, and the like.

In an implementation, the transceiver 20 of the network-side device sends a data signal, a CSI-RS, and corresponding CSI-RS multiplexing indication information to the transceiver 10 of the terminal using an antenna. The transceiver 10 of the terminal receives, by using an antenna, the data signal, the CSI-RS, and the corresponding CSI-RS multiplexing indication information that are sent by the transceiver 20 of the network-side device; and the processor 11 of the terminal parses, based on the CSI-RS multiplexing indication information, the data signal in an orthogonal frequency division multiplexing (OFDM) symbol indicated by the CSI-RS multiplexing indication information, and demodulates the data signal together with a second data signal that is in a transmission timeslot in which the OFDM symbol is located, where frequency division multiplexing is performed on the data signal and the CSI-RS in the OFDM symbol. The transmission timeslot herein is usually a time unit for data modulation and demodulation, and usually may be one TTI (transmission time interval, transmission time interval).

Alternatively, in another implementation, the transceiver 20 of the network-side device sends, to the transceiver 10 of the terminal by using an antenna, all analog beam information of a CSI-RS in a transmission timeslot and information about an analog beam for transmitting data. the transceiver 10 of the terminal receives all the analog beam information of the CSI-RS in the transmission timeslot and the information about the analog beam for transmitting the data; the processor 11 of the terminal determines whether there is a CSI-RS analog beam that is the same as an analog beam for transmitting a data signal of the terminal. When the processor 11 determines that there is a CSI-RS analog beam being the same as an analog beam for transmitting a data signal of the terminal, the processor 11 determines that the data signal is mapped into an OFDM symbol in which the CSI-RS is located. Further, the processor 11 of the terminal parses the data signal in the OFDM symbol into which the data signal is mapped. When the processor 11 determines that there is no CSI-RS analog beam being the same as an analog beam for transmitting a data signal of the terminal, the processor 11 determines that the data signal is not mapped into an OFDM symbol in which the CSI-RS is located.

It should be noted that the processor 11 of the terminal and the processor 21 of the network-side device each may be a central processing unit (central processing unit, CPU for short), a network processor (network processor, NP for short), or a combination of a CPU and an NP. The processor may further include a hardware chip. The hardware chip may be an application-specific integrated circuit (application-specific integrated circuit, ASIC for short), a programmable logic device (programmable logic device, PLD for short), or a combination thereof. The PLD may be a complex programmable logic device (complex programmable logic device, CPLD for short), a field-programmable gate array (field-programmable gate array, FPGA for short), generic array logic (generic array logic, GAL for short), or any combination thereof.

The memory 12 of the terminal and the memory 22 of the network-side device each may include a volatile memory (volatile memory), for example, a random access memory (random access memory, RAM for short); and may further include a nonvolatile memory (nonvolatile memory), for example, a flash memory (flash memory), a hard disk (hard disk drive, HDD for short), or a solid-state drive (solid-state drive, SSD for short). Alternatively, the memory may include a combination of the foregoing types of memory.

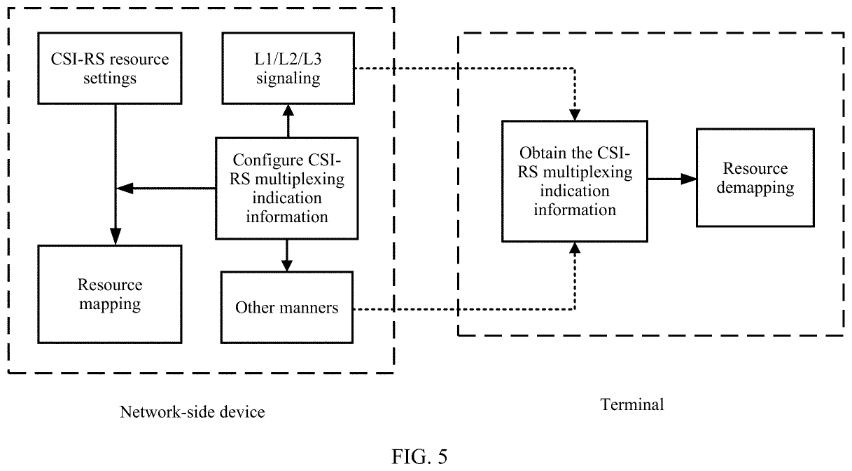

In this disclosure, multiplexing on the CSI-RS and the data signal is implemented based on the CSI-SI multiplexing indication information. FIG. 5 is a schematic diagram illustrating data multiplexing between a terminal and a network-side device according to an embodiment of the disclosure. With reference to FIG. 4, a data multiplexing method in an embodiment of this disclosure is as follows:

Step 1: A processor 21 of a network-side device determines, based on an actual application scenario or a function of a CSI-RS and based on a resource usage status of an OFDM symbol in which the CSI-RS is located, whether frequency division multiplexing needs to be performed on a data signal of a terminal and the CSI-RS, and OFDM symbols in which multiplexing is to be performed; and then configures CSI-RS multiplexing indication information.

In some embodiments, there are the following cases:

Case 1. When the CSI-RS is used to perform channel state measurement on a terminal covered by an analog beam, and the OFDM symbol in which the CSI-RS is located has an idle resource, the processor 21 of the network-side device determines that frequency division multiplexing is to be performed on a data signal of the terminal and the CSI-RS.

Case 2. When the CSI-RS is used to perform channel state measurement on a terminal covered by an analog beam, but the OFDM symbol in which the CSI-RS is located does not have an idle resource, the processor 21 of the network-side device determines that frequency division multiplexing is not to be performed on a data signal of the terminal and the CSI-RS.

Case 3. When the CSI-RS is used for beam measurement, the processor 21 of the network-side device determines that frequency division multiplexing is not to be performed on the data signal of the terminal and the CSI-RS.

Step 2: The processor 21 on a network-side device side performs resource mapping between data and a pilot OFDM symbol based on content of the configured CSI-RS multiplexing indication information.

Step 3: A transceiver 20 of the network-side device selects, based on a configuration mode of the CSI-RS multiplexing indication information, a proper mode to notify the terminal of the CSI-RS multiplexing indication information, so that the terminal can perform resource demapping correctly. For example, the CSI-RS multiplexing indication information is carried by using L1/L2/L3 signaling, or other modes may be used.

Step 4: A transceiver 10 of the terminal receives the CSI-RS multiplexing indication information, and a processor 11 of the terminal performs resource demapping based on the CSI-RS multiplexing indication information.

In step 1, the following several implementations are available for the processor 21 of the network-side device to configure the CSI-RS multiplexing indication information:

1. If frequency division multiplexing is performed on the CSI-RS and the data signal of the terminal in all OFDM symbols, the processor 21 of the network-side device configures the CSI-RS multiplexing indication information to be used to indicate that frequency division multiplexing is performed in all the OFDM symbols.

2. When frequency division multiplexing is not performed on the CSI-RS and the data signal of the terminal in any OFDM symbol, the processor 21 of the network-side device configures the CSI-RS multiplexing indication information to be used to indicate that frequency division multiplexing is not performed in any OFDM symbol.

3. When frequency division multiplexing is performed on the CSI-RS and the data signal of the terminal in some OFDM symbols, the processor 21 of the network-side device configures the CSI-RS multiplexing indication information to be used to indicate whether frequency division multiplexing is performed in each OFDM symbol.

4. When frequency division multiplexing is performed on the CSI-RS and the data signal of the terminal in some OFDM symbols, the processor 21 of the network-side device configures the CSI-RS multiplexing indication information to be used to indicate the OFDM symbols in which frequency division multiplexing is performed, or the processor 21 of the network-side device configures the indication information to be used to indicate an OFDM symbol in which frequency division multiplexing is not performed.

The following describes several implementation processes in which the network-side device configures the CSI-RS multiplexing indication information and sends the CSI-RS multiplexing indication information to the terminal according to embodiments of this disclosure.

### Embodiment 1

To flexibly indicate a status of multiplexing on a CSI-RS and a data signal of a terminal, a transceiver 20 of a network-side device carries the CSI-RS multiplexing indication information by using L1/L2 signaling (L1/L2 signaling protocols or L1/L2 signaling data).

When multiplexing is performed on the CSI-RS and the data signal of the terminal in all OFDM symbols or multiplexing is not performed on the CSI-RS and the data signal of the terminal in any OFDM symbol, a processor 21 of the network-side device may select a 1-bit resource from downlink control information (Downlink control information, DCI) to mark the information, where 0 represents “no multiplexing”, and 1 represents “multiplexing”; or 0 represents “no multiplexing”, and 1 represents “no multiplexing”.

When multiplexing is not performed on the CSI-RS and the data signal of the terminal in different OFDM symbols simultaneously, the processor 21 of the network-side device may configure 1-bit indication information for each OFDM symbol in which the CSI-RS is located, to independently indicate whether multiplexing is performed on the CSI-RS and the data signal of the terminal.

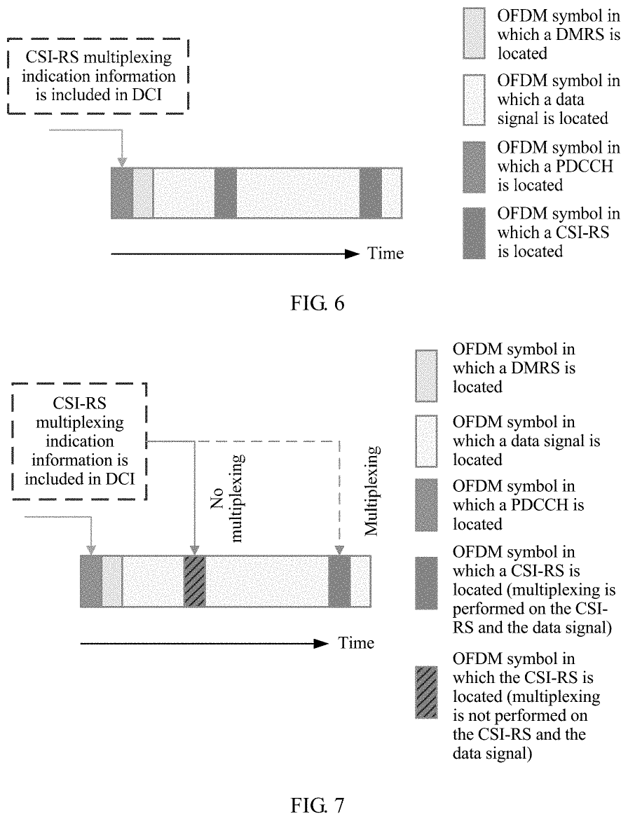

FIG. 6 is a schematic diagram of CSI-RS multiplexing indication information in Embodiment 1 of a data multiplexing method according to some embodiments of this disclosure. The OFDM symbols include an OFDM symbol portion in which a demodulation reference signal (demodulation reference signal, DMRS) is located, an OFDM symbol portion in which a data signal is located, an OFDM symbol portion in which a physical downlink control channel (Physical Downlink Control Channel, PDCCH) is located, and an OFDM symbol portion in which a CSI-RS is located. The CSI-RS multiplexing indication information is carried by using DCI. A processor 11 of the terminal obtains the CSI-RS multiplexing indication information by decoding the PDCCH.

It should be understood that, herein, that the network-side device carries the CSI-RS multiplexing indication information by using DCI signaling is merely an example. In other implementations, the CSI-RS multiplexing indication information may alternatively be carried by using L2 signaling, for example, MAC CE (medium access control control element, medium access control control element) signaling.

### Embodiment 2

When a CSI-RS is mapped into a plurality of OFDM symbols, but frequency division multiplexing is not performed on the CSI-RS and a data signal of a terminal only in some OFDM symbols, a processor 21 of a network-side device may indicate only some information about multiplexing on the CSI-RS and user data, to reduce overheads of indication information. A specific indication method includes the following:

1. The processor 21 of the network-side device determines to indicate only OFDM symbols into which the data signal is not mapped, and a transceiver 20 of the network-side device directly notifies, by using DCI, the terminal of the OFDM symbols into which the data signal is not mapped.

2. The processor 21 of the network-side device determines to indicate only OFDM symbols into which the data signal is mapped, and a transceiver 20 of the network-side device directly notifies, by using DCI, the terminal of the OFDM symbols into which the data signal is mapped.

FIG. 7 is a schematic diagram of CSI-RS multiplexing indication information in Embodiment 2 of the data multiplexing method in which DCI is used to indicate CSI-RS multiplexing in a plurality of OFDM symbols according to some embodiments of the present disclosure. Only the OFDM symbols in which multiplexing is performed need to be indicated in the DCI information, and by default, multiplexing is not performed in other OFDM symbols in which the CSI-RS is located. Alternatively, only the OFDM symbols in which multiplexing is not performed need to be indicated in the DCI, and by default, other OFDM symbols in which the CSI-RS is located are OFDM symbols in which multiplexing is performed. Generally, when there are more OFDM symbols in which multiplexing is performed, an OFDM symbol in which multiplexing is not performed is indicated; or if there are more OFDM symbols in which multiplexing is not performed, an OFDM symbol in which multiplexing is performed is indicated, to reduce overheads of indication information.

### Embodiment 3

In some application scenarios, some terminals may remain in a same state for a long time. In this case, CSI-RS multiplexing indication information needs to be carried by using L3 signaling, for example, radio resource control (Radio Resource Control, RRC) signaling, to avoid an increase in L1/L2 signaling overheads. For example, when a terminal resides within a coverage area of a beam for a long time with good communication quality, beam scanning does not need to be performed frequently; or when a terminal is moving at a high speed, beam scanning may be performed frequently.

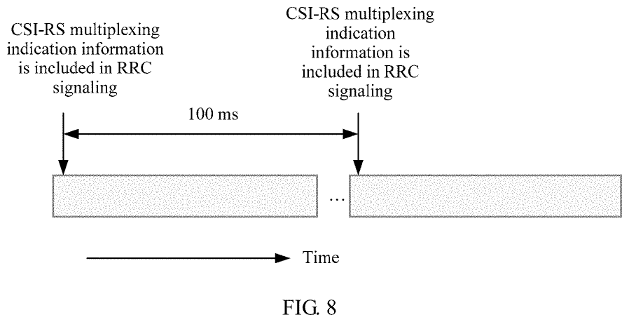

FIG. 8 is a schematic diagram in which CSI-RS multiplexing indication information is carried by using RRC signaling. A processor 21 of a network-side device carries the CSI-RS multiplexing indication information by using RRC, and sends the RRC to a terminal by using a transceiver 20 of the network-side device. A relatively long update period may be used for the RRC signaling, to avoid frequent signaling overheads.

It should be understood that the RRC signaling is merely an example, and other L3 signaling may also be used to carry the CSI-RS multiplexing indication information, provided that the technical solutions of this disclosure can be implemented.

### Embodiment 4

In this embodiment, more flexible CSI-RS resource settings (CSI-RS resource settings) and CSI report settings (CSI report settings) are implemented by using L3 signaling in combination with L1/L2 signaling, to meet various different CSI measurement requirements. In this embodiment, CSI-RS multiplexing indication information is configured while a CSI-RS resource is configured. In other words, the CSI-RS multiplexing indication information is included in CSI-RS resource settings (CSI-RS resource settings) information, CSI-RS settings (CSI-RS settings) information, or CSI-RS initial settings (CSI-RS initial settings) information. The CSI-RS multiplexing indication information is used, by a network-side device based on current application and a scheduling requirement, to directly indicate a location of an OFDM symbol that corresponds to a CSI-RS and in which frequency division multiplexing is performed, or indicate a location of an OFDM symbol in which multiplexing is not performed. An indication method is as follows:

1. A processor 21 of the network-side device performs CSI-RS initial setting. During the CSI-RS initial setting, based on an application scenario of a terminal (for example, the terminal does not move rapidly within a coverage area of a beam), a default multiplexing mode is set as a mode of multiplexing on a CSI-RS and a data signal of the terminal in a relatively long communication period.

2. In a communication process, as the application scenario of the terminal changes, for example, the terminal enters a high-speed movement state, the processor 21 of the network-side device determines that previous settings about the CSI-RS multiplexing indication information are no longer applicable. In this case, the processor 21 of the network-side device updates the settings of the CSI-RS multiplexing indication information, and a transceiver 20 notifies the terminal of a new CSI-RS multiplexing mode by using L1/L2 signaling.

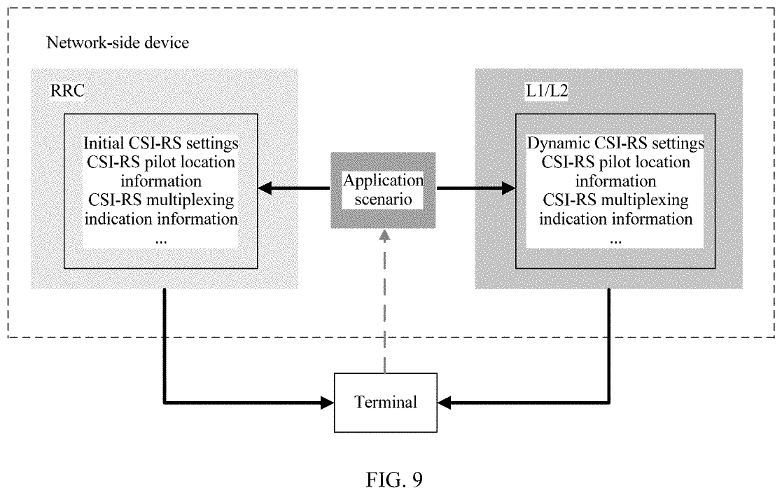

FIG. 9 is a schematic diagram illustrating CSI-RS multiplexing indication information of the data multiplexing method in Embodiment 4. The change of the application scenario may be determined by the processor 21 of the network-side device based on channel quality that is fed back by the terminal in real time. If the terminal can determine the application scenario of the terminal (i.e., its own application scenario), the terminal may also actively report the application scenario to the network-side device by using a transceiver 10, for decision making.

In this implementation solution, the CSI-RS multiplexing indication information is a part of CSI-RS settings, and is updated together with the CSI-RS settings. Because the CSI settings are also an important part of CSI measurement, this also facilitates the network-side device in setting CSI-RS multiplexing manners based on different application scenarios, in addition to facilitating flexible settings.

Embodiment 1 to Embodiment 4 describe implementations in which the network-side device configures the CSI-RS multiplexing indication information and sends the CSI-RS multiplexing indication information to the terminal by using different signaling protocols or signaling data in different signaling protocols and/or layers. On a terminal side, the terminal receives the CSI-RS multiplexing indication information delivered by the network-side device; and then parses a data signal in an OFDM symbol in which a CSI-RS is located, where multiplexing is performed on the CSI-RS and the data signal, and demodulates the data signal together with a second data signal that is in a transmission timeslot in which the OFDM symbol is located. This is a technology well-known to a person skilled in the art. Details are not described herein.

In another implementation, the terminal may deduce, based on analog beam information of a CSI-RS, whether a data signal is mapped into an OFDM symbol in which the CSI-RS is located. The following provides detailed descriptions by using Embodiment 5.

### Embodiment 5

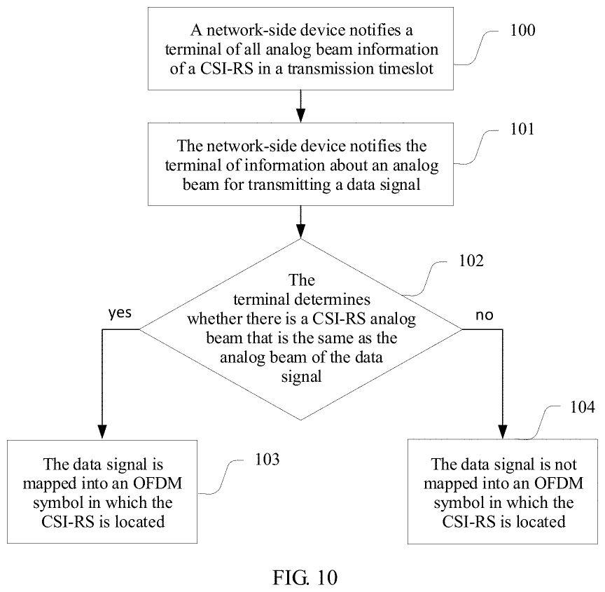

A process of a data multiplexing method provided in this embodiment is shown in FIG. 10:

Step 100: A transceiver 20 of a network-side device notifies a terminal of all analog beam information of a CSI-RS in a transmission timeslot. In some embodiments, the transceiver 20 of the network-side device notifies the terminal of all the analog beam information of the CSI-RS in the transmission timeslot by using L1/L2/L3 signaling, for example, DCI, MAC CE, or RRC signaling. The information may be an analog beam identifier, a CSI-RS resource identifier and a port number, or the like. Other methods that can represent an analog beam of the CSI-RS should also be included in this embodiment of this disclosure.

Step 101: The transceiver 20 of the network-side device notifies the terminal of information about an analog beam for transmitting a data signal. In some embodiments, before starting data signal transmission, the transceiver 20 of the network-side device notifies, by using DCI or RRC, or in another manner, the terminal of the information about the analog beam for transmitting the data signal.

Step 102: After a transceiver 10 of the terminal receives the analog beam information of the CSI-RS and the information about the analog beam for transmitting the data signal, a processor 11 of the terminal determines whether there is an analog beam that corresponds to the CSI-RS and that is the same as the analog beam for transmitting the data signal of the terminal.

Step 103: When there is an analog beam that is corresponding to the CSI-RS and that is the same as the analog beam for transmitting the data signal of the terminal (yes in 102), the processor 11 of the terminal determines that the data signal is mapped into an OFDM symbol in which the CSI-RS is located, and further, the processor 11 of the terminal parses the data signal in the OFDM symbol in which the CSI-RS is located.

Step 104: When there is no analog beam that corresponds to the CSI-RS and that is the same as the analog beam for transmitting the data signal of the terminal (no in 102), the processor 11 of the terminal considers that the data signal is not mapped into any OFDM symbol in which the CSI-RS is located.

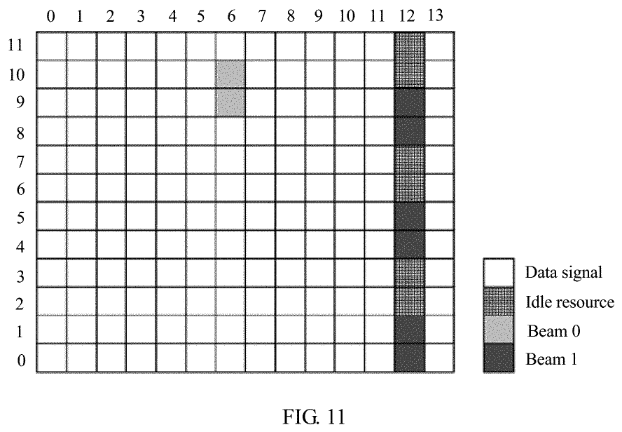

FIG. 11 is a schematic diagram of deducing a multiplexing status by a processor 11 of a terminal based on analog beam information of a CSI-RS in Embodiment 5 of a data multiplexing method according to some embodiments of the present disclosure. The analog axis represents time, and the vertical axis represents subcarriers. An analog beam for transmitting a data signal of the terminal is a beam 0. The CSI-RS is sent on the beam 0 in an OFDM symbol 6. The CSI-RS is sent on a beam 1 in an OFDM symbol 12. In this case, a network-side device enables the terminal to perform beam measurement on the beam 1. Neither the network-side device nor the terminal is sure whether the beam 1 can cover the terminal. Therefore, the terminal determines that frequency division multiplexing is not performed on the data signal and the CSI-RS in the OFDM symbol 12.

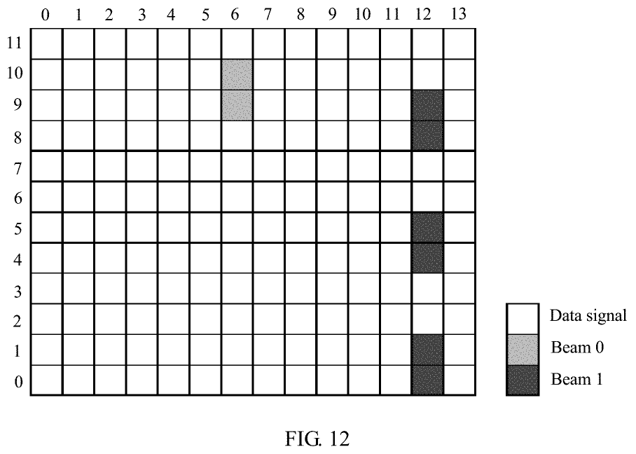

In addition, during high-frequency communication, a network-side device and a terminal may maintain a backup list of a plurality of beam pairs with relatively good communication quality, to implement more robust and reliable transmission. One beam pair includes information about a corresponding pair of transmit analog beam and receive analog beam. Therefore, even if a transmit analog beam corresponding to a CSI-RS is different from an analog beam for transmitting a data signal of the terminal, if the transmit analog beam corresponding to the CSI-RS and a receive analog beam corresponding to the terminal at a current moment are in the backup list of beam pairs, a processor 11 of the terminal also determines that multiplexing is performed on the data and the CSI-RS. Therefore, in this case, as shown in FIG. 12, a beam 1 is paired with a receive analog beam of the terminal in an OFDM symbol 12, and this can also implement reliable communication between the network-side device and the terminal.

It should be understood that the steps or operations shown in the methods in the foregoing embodiments are merely examples, and other operations or various operation variations may alternatively be performed. In addition, in specific implementations, the steps may be performed in a sequence different from that in the embodiments of this disclosure, and not all the operations or steps shown in the embodiments of this disclosure may be necessarily performed. Alternatively, more operations or steps than those shown in the embodiments of this disclosure may be performed.

It should be further understood that sequence numbers of the foregoing processes do not mean execution sequences in various embodiments of this disclosure. The execution sequences of the processes should be determined based on functions and internal logic of the processes, and should not be construed as any limitation on the implementation processes of the embodiments of this disclosure.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this disclosure, it should be understood that the disclosed system, apparatus, and method may be implemented in other manners. For example, the described apparatus embodiment is merely an example. For example, the unit division is merely logical function division, and there may be another division manner during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, to be specific, may be located in one position, or may be distributed on a plurality of network units. Some or all of the units may be selected based on actual requirements to achieve the objectives of the solutions of the embodiments.

In addition, the function units in the embodiments of this disclosure may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this disclosure. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A data multiplexing method, comprising:
sending, by a network-side device, a channel state information-reference signal (CSI-RS) and a data signal to a terminal, wherein the CSI-RS is used for channel state measurement or beam quality measurement; and
sending, by the network-side device, CSI-RS multiplexing indication information to the terminal, wherein the CSI-RS multiplexing indication information is used to indicate whether frequency division multiplexing is performed on the CSI-RS and the data signal.

2. The data multiplexing method according to claim 1, before sending the CSI-RS multiplexing indication information to the terminal, further comprising:
when the CSI-RS is used to perform channel state measurement on the terminal, and an orthogonal frequency division multiplexing OFDM symbol in which the CSI-RS is located has an idle resource, determining that frequency division multiplexing is to be performed on the data signal and the CSI-RS; or
when the CSI-RS is used to perform channel state measurement on the terminal, but an OFDM symbol in which the CSI-RS is located does not have an idle resource, determining that frequency division multiplexing is not to be performed on the data signal and the CSI-RS; or
when the CSI-RS is used for beam measurement, determining that frequency division multiplexing is not to be performed on the data signal and the CSI-RS.

3. The data multiplexing method according to claim 2, after determining that the frequency division multiplexing is to be performed on the data signal and the CSI-RS, further comprising:
mapping, by the network-side device, the data signal into a resource of the OFDM symbol in which the CSI-RS is located.

4. The data multiplexing method according to claim 1, wherein
when the frequency division multiplexing is performed on the CSI-RS and the data signal in all OFDM symbols, the CSI-RS multiplexing indication information is used to indicate that the frequency division multiplexing is performed in all the OFDM symbols; or
when the frequency division multiplexing is not performed on the CSI-RS and the data signal in any OFDM symbol, the CSI-RS multiplexing indication information is used to indicate that the frequency division multiplexing is not performed in any OFDM symbol; or
when the frequency division multiplexing is performed on the CSI-RS and the data signal in some OFDM symbols, the CSI-RS multiplexing indication information is used to indicate whether the frequency division multiplexing is performed in each OFDM symbol; or
when frequency division multiplexing is performed on the CSI-RS and the data signal in some OFDM symbols, the CSI-RS multiplexing indication information is used to indicate the OFDM symbols in which the frequency division multiplexing is performed; or
when the frequency division multiplexing is performed on the CSI-RS and the data signal in some OFDM symbols, the CSI-RS multiplexing indication information is used to indicate an OFDM symbol in which frequency division multiplexing is not performed.

5. The data multiplexing method according to claim 1, wherein sending the CSI-RS multiplexing indication information to the terminal comprises:
carrying, by the network-side device, the CSI-RS multiplexing indication information using L1/L2/L3 signaling data, and sending the L1/L2/L3 signaling to the terminal.

6. The data multiplexing method according to claim 1, wherein the CSI-RS multiplexing indication information is contained in CSI-RS resource settings information.

7. The data multiplexing method according to claim 6, wherein the CSI-RS multiplexing indication information is updated synchronously with the CSI-RS resource settings information or is updated as an application scenario of the terminal changes.

8. A data parsing method, comprising:
receiving, by a terminal, a channel state information-reference signal (CSI-RS), a data signal, and CSI-RS multiplexing indication information from a network-side device, wherein the CSI-RS is used for channel state measurement or beam quality measurement; and
parsing, by the terminal, the data signal in an orthogonal frequency division multiplexing (OFDM) symbol indicated by the CSI-RS multiplexing indication information, wherein frequency division multiplexing is performed on the data signal and the CSI-RS in the OFDM symbol.

9. The data parsing method according to claim 8, wherein parsing the data signal in the OFDM symbol comprises:
obtaining, by the terminal, the data signal from the OFDM symbol according to an indication of the CSI-RS multiplexing indication information; and
demodulating the data signal together with a second data signal that is in a transmission timeslot in which the OFDM symbol is located.

10. A network-side device, comprising:
a transceiver configured to send a channel state information-reference signal CSI-RS and a data signal to a terminal, wherein the CSI-RS is used for channel state measurement or beam quality measurement; and
the transceiver is further configured to send CSI-RS multiplexing indication information to the terminal, wherein the CSI-RS multiplexing indication information is used to indicate whether frequency division multiplexing is performed on the data signal and the CSI-RS.

11. The network-side device according to claim 10, further comprising a processor configured to:
when the CSI-RS is used to perform channel state measurement on the terminal, and an OFDM symbol in which the CSI-RS is located has an idle resource, determine that the frequency division multiplexing is performed on the data signal and the CSI-RS; or
when the CSI-RS is used to perform channel state measurement on the terminal, and an OFDM symbol in which the CSI-RS is located does not have an idle resource, determine that frequency division multiplexing is not to be performed on the data signal and the CSI-RS; or
when the CSI-RS is used for beam measurement, determine that frequency division multiplexing is not to be performed on the data signal and the CSI-RS.

12. The network-side device according to claim 11, wherein after determining that the frequency division multiplexing is performed on the data signal and the CSI-RS, the processor is further configured to map the data signal into the resource of the OFDM symbol in which the CSI-RS is located.

13. The network-side device according to claim 10, wherein when the frequency division multiplexing is performed on the CSI-RS and the data signal in all OFDM symbols, the CSI-RS multiplexing indication information is used to indicate that frequency division multiplexing is performed in all the OFDM symbols; or
when the frequency division multiplexing is not performed on the CSI-RS and the data signal in any OFDM symbol, the CSI-RS multiplexing indication information is used to indicate that the frequency division multiplexing is not performed in any OFDM symbol; or
when the frequency division multiplexing is performed on the CSI-RS and the data signal in some OFDM symbols, the CSI-RS multiplexing indication information is used to indicate whether frequency division multiplexing is performed in each OFDM symbol; or
when the frequency division multiplexing is performed on the CSI-RS and the data signal in some OFDM symbols, the CSI-RS multiplexing indication information is used to indicate the OFDM symbols in which frequency division multiplexing is performed; or
when the frequency division multiplexing is performed on the CSI-RS and the data signal in some OFDM symbols, the CSI-RS multiplexing indication information is used to indicate an OFDM symbol in which frequency division multiplexing is not performed.

14. The network-side device according to claim 10, wherein the transceiver carries the CSI-RS multiplexing indication information by using L1/L2/L3 signaling data, and sends the L1/L2/L3 signaling data to the terminal.

15. The network-side device according to claim 10, wherein the CSI-RS multiplexing indication information is contained in CSI-RS resource settings information.

16. The network-side device according to claim 15, wherein the CSI-RS multiplexing indication information is updated synchronously with the CSI-RS resource settings information or is updated as an application scenario of the terminal changes.
